(19) United States
(12) Patent Application Publication
(10) Pub. No.: US 2020/0142623 A1
(43) Pub. Date: May 7, 2020

(54) STORAGE DEVICE AND ELECTRONIC DEVICE MANAGING DATA TRANSMITTED TO STORAGE DEVICE

(71) Applicant: Samsung Electronics Co., Ltd., Suwon-si (KR)

(72) Inventors: Yongmyung Lee, Hwaseong-si (KR); Seunguk Shin, Seoul (KR); Jieon Seol, Hwaseong-si (KR); Jinyoung Choi, Suwon-si (KR)

(73) Assignee: Samsung Electronics Co., Ltd., Suwon-si (KR)

(21) Appl. No.: 16/456,988

(22) Filed: Jun. 28, 2019

(30) Foreign Application Priority Data
Nov. 7, 2018 (KR) 10-2018-0135853

(51) Int. Cl. G06F 3/06

(52) U.S. Cl. CPC G06F 3/0644; G06F 3/0679; G06F 3/0604

(57) ABSTRACT

An electronic device includes a memory and a processor. The memory stores first data with regard to a first position of a data area of a storage device and second data with regard to a second position of the data area. When a size of the first data included in a first page is smaller than a reference size and a size of the second data included in a second page different from the first page is smaller than the reference size, the processor outputs data blocks including the first data and the second data, and outputs first metadata about the first position with regard to the first data and second metadata about the second position with regard to the second data. A size of the data blocks is smaller than a sum of a size of the first page and a size of the second page.

### CROSS-REFERENCE TO RELATED APPLICATIONS

This application claims priority under 35 U.S.C. § 119 from Korean Patent Application No. 10-2018-0135853 filed on Nov. 7, 2018, in the Korean Intellectual Property Office, the disclosure of which is incorporated by reference herein in its entirety.

### BACKGROUND

### 1. Field

Embodiments relate to a storage device and an electronic device, and more particularly, relate to a storage device and an electronic device managing data which are transmitted to the storage device.

### 2. Description of Related Art

Functions of an electronic device are being diversified as a semiconductor technology develops. A storage device provides operations for an electronic device to perform a function. In detail, the storage device provides data which the electronic device uses to perform a function or stores data which are processed by the electronic device.

The electronic device accesses the storage device by using a host device. The host device may be a processor such as a central processing unit (CPU), an application processor (AP), or a graphic processing unit (GPU). The host device transmits data processed at the electronic device to the storage device such that the processed data are stored to the storage device.

The storage device receives data on a given basis. Accordingly, the host device outputs data on a given basis. For example, the host device outputs data on a block basis. In this case, meaningless data may be included in data output from the host device. Also, data which are transmitted from the host device to the storage device unnecessarily increase in amount.

### SUMMARY

It is an aspect to provide an electronic device which reduces the amount of data to be transmitted to a storage device.

According to an aspect of an exemplary embodiment, there is provided an electronic device comprising a memory configured to store first partial data generated with regard to a first position of a data area of a storage device and second partial data generated with regard to a second position of the data area; and a processor, wherein, when a first size of the first partial data included in a first page is smaller than a reference size and a second size of the second partial data included in a second page different from the first page is smaller than the reference size, the processor outputs one or more data blocks including the first partial data and the second partial data, and outputs first metadata including first information about the first position with regard to the first partial data and second metadata including second information about the second position with regard to the second partial data, wherein a size of the one or more data blocks is smaller than a first sum of a size of the first page and a size of the second page.

According to another aspect of an exemplary embodiment, there is provided a storage device comprising a first memory configured to store one or more data blocks generated by merging partial data respectively included in pages and to store first metadata of first partial data, which are generated with regard to a first position, from among the partial data; and a second memory configured to store the first partial data at a second position associated with the first position by using the first metadata, wherein a size of the one or more data blocks is smaller than a size of each of the pages.

According to another aspect of an exemplary embodiment, there is provided a storage device comprising a first memory configured to receive one or more data blocks generated by merging partial data respectively included in pages and to store the partial data; and a second memory, wherein, in response to a signal including first information about a first position of the first memory and second information about a second position being received at the first memory, the second memory stores, at the second position, first partial data, which are stored at the first position, from among the partial data based on the signal, wherein a size of the one or more data blocks is smaller than a size of the pages. And wherein a size of the partial data is smaller than a size of each of the pages.

According to another aspect of an exemplary embodiment, there is provided a processor configured to merge, into a merged page, a plurality of partial pages each including file data, a size of which is less than a reference size, write metadata in the merged page, the metadata including information about the file data in the merged page, and generate one or more data blocks of a block size from the merged page; and a storage device configured to receive the one or more data blocks from the processor and write the one or more data blocks into a memory based on the metadata.

### BRIEF DESCRIPTION OF THE FIGURES

The above and other aspects will become apparent by describing in detail exemplary embodiments thereof with reference to the accompanying drawings, in which:

FIG. 1 is a block diagram illustrating an exemplary configuration of an electronic device according to an embodiment;

FIG. 2 is a block diagram illustrating an exemplary configuration of an electronic device according to an embodiment;

FIG. 3 is a conceptual diagram for describing a method in which a processor of the electronic device illustrated in FIG. 2 manages data, according to an embodiment;

FIG. 4 is a conceptual diagram for describing a method in which a processor of the electronic device illustrated in FIG. 2 manages data, according to an embodiment;

FIG. 5 is a conceptual diagram for describing a method in which a processor of the electronic device illustrated in FIG. 2 manages data, according to an embodiment;

FIG. 6 is a conceptual diagram for describing a method in which a processor of the electronic device illustrated in FIG. 2 manages data, according to an embodiment;

FIG. 7 is a flowchart for describing a method in which a processor of the electronic device illustrated in FIG. 2 manages data, according to an embodiment;

FIG. 8 is a conceptual diagram for describing a method of storing data at a storage device of the electronic device illustrated in FIG. 2, according to an embodiment;

FIG. 9 is a conceptual diagram for describing a method in which a storage device of the electronic device illustrated in FIG. 2 stores file data in a data area, according to an embodiment;

FIG. 10 is a flowchart for describing a method in which a storage device of the electronic device illustrated in FIG. 2 stores file data in a data area, according to an embodiment;

FIG. 11 is a conceptual diagram for describing a method in which a storage device of the electronic device illustrated in FIG. 2 reads file data, according to an embodiment;

FIG. 12 is a block diagram illustrating an exemplary configuration of an electronic device according to an embodiment;

FIG. 13 is a conceptual diagram for describing a method in which a storage device of the electronic device illustrated in FIG. 12 stores file data to a data area, according to an embodiment;

FIG. 14 is a conceptual diagram for describing a method in which a storage device of the electronic device illustrated in FIG. 12 stores file data in a data area, according to an embodiment; and

FIG. 15 is a flowchart for describing a method in which a storage device of the electronic device illustrated in FIG. 12 stores file data in a data area.

### DETAILED DESCRIPTION

Below, various embodiments will be described in detail and clearly to such an extent that one of ordinary skill in the art may easily implement the various embodiments.

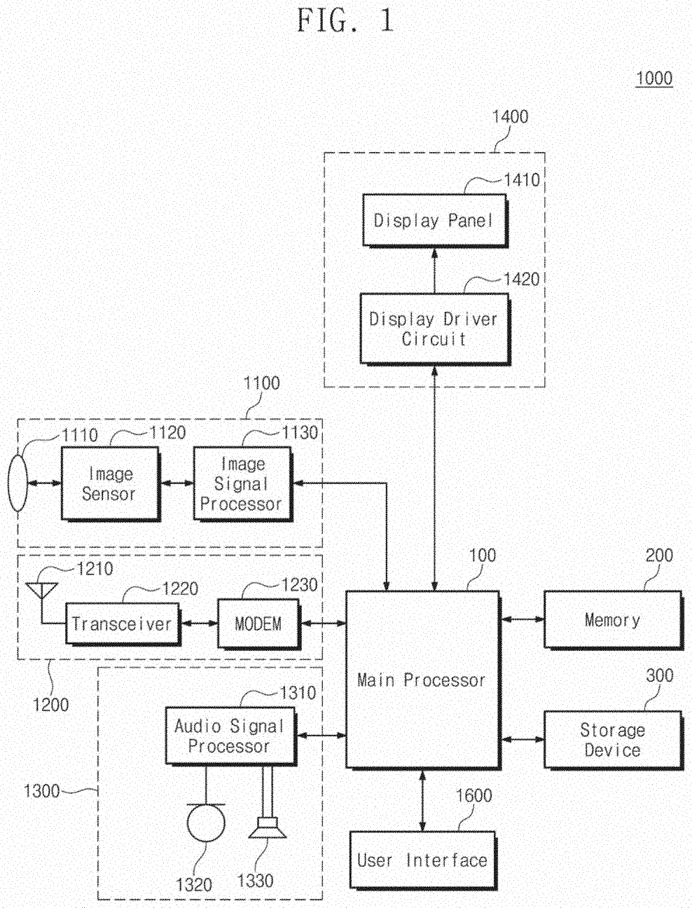

FIG. 1 is a block diagram illustrating an exemplary configuration of an electronic device according to an embodiment.

An electronic device 1000 may be implemented with one of various types of electronic devices such as a smartphone, a tablet personal computer (PC), a laptop PC, an e-book reader, an MP3 player, a wearable device, etc.

The electronic device 1000 may include various electronic circuits. For example, the electronic circuits of the electronic device 1000 may include a main processor 100, a memory 200, a storage device 300, an image processing block 1100, a communication block 1200, an audio processing block 1300, a display device 1400, and a user interface 1600.

The image processing block 1100 may receive a light through a lens 1110. An image sensor 1120 and an image signal processor 1130 included in the image processing block 1100 may generate image data associated with an external subject, based on the received light.

The communication block 1200 may exchange signals with an external device/system through an antenna 1210. A transceiver 1220 and a Modulator/Demodulator (MODEM) 1230 of the communication block 1200 may process signals, which are exchanged with the external device/system, in compliance with various wireless communication protocols.

The audio processing block 1300 may process sound information by using an audio signal processor 1310, thus playing and outputting the audio. The audio processing block 1300 may receive an audio input through a microphone 1320. The audio processing block 1300 may output the played audio through a speaker 1330.

The display device 1400 may receive data from an external device (e.g., the main processor 100). A display driver circuit 1420 may display an image in a display panel 1410 based on data input to the display device 1400.

The memory 200 may store data which are used for an operation of the electronic device 1000. For example, the memory 200 may temporarily store data processed by or to be processed by the main processor 100. For example, the memory 200 may include a volatile memory such as a static random access memory (SRAM), a dynamic RAM (DRAM), or a synchronous DRAM (SDRAM), and/or a nonvolatile memory such as a phase-change RAM (PRAM), a magneto-resistive RAM (MRAM), a resistive RAM (ReRAM), or a ferroelectric RAM (FRAM).

The storage device 300 may be a physical storage device. In this case, the storage device 300 may include one or more nonvolatile memories, a memory controller, and a buffer. The nonvolatile memory may store data regardless of whether power is supplied to the nonvolatile memory. For example, the nonvolatile memory may include at least one of a flash memory, a PRAM, an MRAM, a ReRAM, a FRAM, etc. For example, the nonvolatile memory may include a removable memory such as a secure digital (SD) card, and/or an embedded memory such as an embedded multimedia card (eMMC).

Alternatively, the storage device 300 may be a virtual storage device which is operated by a virtual storage driver in an operating system. In this case, the storage device 300 may store data without limitations on a physical storage device.

The user interface 1600 may arbitrate communication between a user and the electronic device 1000. For example, the user interface 1600 may include input interfaces such as a keypad, a button, a touch screen, a touch pad, a gyroscope sensor, a vibration sensor, and/or an acceleration sensor. For example, the user interface 1600 may include output interfaces such as a motor and/or a LED lamp, etc.

The main processor 100 may control overall operations of the components of the electronic device 1000. The main processor 100 may process various operations for the purpose of operating the electronic device 1000. For example, the main processor 100 may be implemented with an operation processing device/circuit, which includes one or more processor cores, such as a general-purpose processor, a special-purpose processor, an application processor, or a microprocessor.

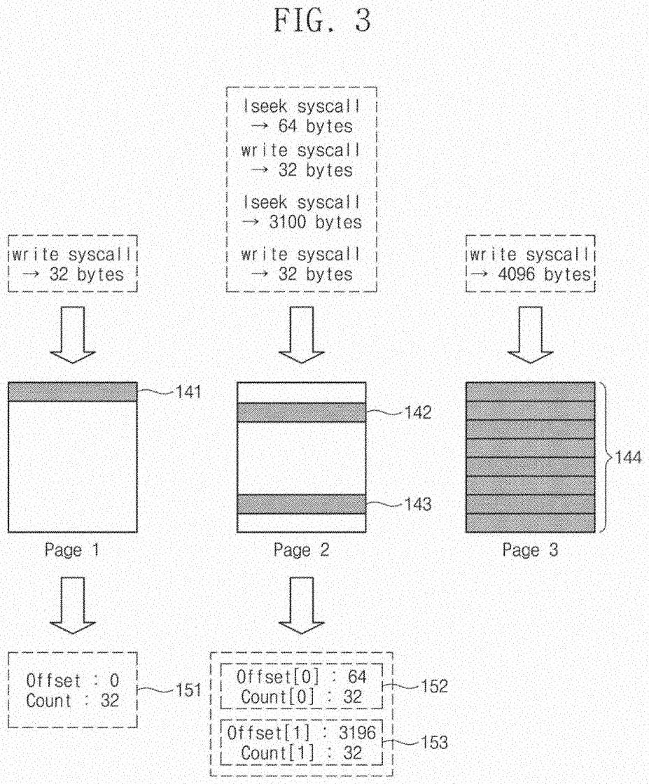

The main processor 100 may process data stored in the memory 200 and/or the storage device 300. The main processor 100 may control the memory 200 and/or the storage device 300 such that processed data are stored to the memory 200 and/or the storage device 300. The main processor 100 may manage data for the purpose of reducing the amount of data to be transmitted to the storage device 300. Exemplary embodiments of methods in which the main processor 100 manages data will be more fully described with reference to FIGS. 3 to 7.

However, the exemplary components illustrated in FIG. 1 are provided for better understanding, and are not intended to limit the inventive concept. For example, in some embodiments, the electronic device 1000 may omit one or more of the components illustrated in FIG. 1; additionally or alternatively, the electronic device 1000 may further include at least one component not illustrated in FIG. 1.

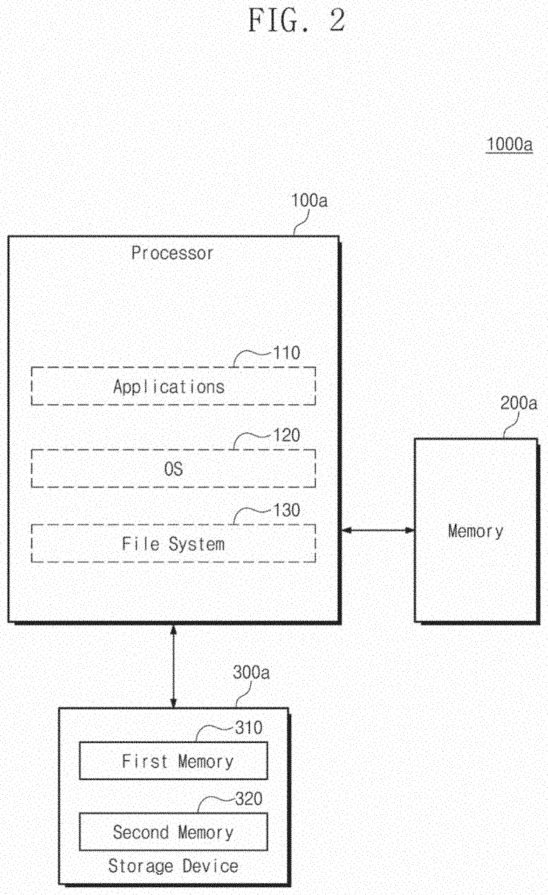

FIG. 2 is a block diagram illustrating an exemplary configuration of an electronic device according to an embodiment.

An electronic device 1000a may include a processor 100a, a memory 200a, and a storage device 300a.

The processor 100a may correspond to the main processor 100 illustrated in FIG. 1. The processor 100a may be a processor such as a central processing unit (CPU), an application processor (AP), or a graphic processing unit (GPU).

The processor 100a may drive an application 110, an operating system (OS) 120, and a file system 130.

The application 110 may be a program which is executed in the operating system 120.

The operating system 120 may record file data at the memory 200a and/or the storage device 300a for the purpose of executing the application 110. Alternatively, the operating system 120 may read file data recorded at the memory 200a and/or the storage device 300a for the purpose of executing the application 110. In the following descriptions, the term “file data” may denote all data which are transmitted from the processor 100a to the memory 200a and/or the storage device 300a. Also, the term “file data” may denote all data which are read from the memory 200a and/or the storage device 300a.

The operating system 120 may include a software layer which processes a system call associated with the file system 130. The operating system 120 may provide a general-purpose interface between different file systems. The operating system 120 may record file data at the memory 200a and/or the storage device 300a by using the file system 130. Also, the operating system 120 may read file data recorded at the memory 200a and/or the storage device 300a by using the file system 130.

The file system 130 may be a system for recording file data at the memory 200a and/or the storage device 300a, and for managing the recorded file data systematically. The file system 130 may be a system such as a File Allocation Table (FAT), a New Technology File System (NTFS), a UNIX File system (UFS), a Second Extended File System (EXT2), EXT3, EXT4, or a Log-structured File System (LFS). The file system 130 may obtain and store metadata associated with attributes of a file. In detail, the metadata may indicate information about attributes of file data such as a size of file data and a position of the storage device 300a at which file data are stored.

A virtual address space may be assigned to the processor 100a. The processor 100a may divide the virtual address space into pages having a given size. For example, in some embodiments, a page size may be 4 KB.

The processor 100a may manage files on a page basis by using the file system 130. The processor 100a may divide file data on a page basis and may store the divided data to the memory 220a and/or to the storage device 300a at pages. The processor 100a may move or process file data on a page basis within the processor 100a.

The processor 100a may output file data to the memory 200a and/or the storage device 300a on a block basis. Also, the processor 100a may receive file data from the memory 200a and/or the storage device 300a on a block basis. The processor 100a may divide a page into blocks by using the file system 130. A block size may be not greater than the page size. For example, in the case where the page size is 4 KB, the block size may be 4 KB or 512 Byte. Below, for convenience of description, it is assumed that the block size is half the page size. But this is only an example. In the case in which the block size is half the page size, the processor 100a may divide one page into two blocks.

The processor 100a may output metadata, as well as file data, to the memory 200a and/or the storage device 300a. Similar to the way the processor 100a manages the file data, the processor 100a may manage metadata on a page basis within the processor 100a. Also, the processor 100a may output metadata on a block basis.

According to an embodiment, the processor 100a may manage data. In detail, the processor 100a may manage file data and/or metadata. The processor 100a may manage data such that the amount of data to be output to the storage device 300a decreases. A method in which the processor 100a manages data will be more fully described with reference to FIGS. 3 to 7.

The memory 200a may correspond to the memory 200 illustrated in FIG. 1. For example, a partial area of the memory 200a may be assigned to a main memory. Below, a description will be given under assumption that the memory 200a is a DRAM, but the inventive concept is not limited thereto.

The memory 200a may store data. The data may be data processed by or to be processed by the processor 100a. For example, the memory 200a may store data used to drive the file system 130.

The storage device 300a may correspond to the storage device 300 illustrated in FIG. 1. The storage device 300a may include a first memory 310 and a second memory 320. The first memory 310 may be a volatile memory such as a SRAM, a DRAM, or a SDRAM. The second memory 320 may be a nonvolatile memory such as a PRAM, an MRAM, a ReRAM, or a FRAM.

The storage device 300a may store data. The data may be data processed by or to be processed by the processor 100a. For example, the data may be file data and metadata.

The storage device 300a may receive file data and metadata on a block basis from the processor 100a. In the case where file data and metadata are received, the storage device 300a may store the file data and the metadata to the first memory 310. The first memory 310 may include a mapping table used to map a virtual address to be used in the processor 100a onto an actual address to be used in the second memory 320. The mapping of the virtual address onto the actual address denotes to allow the virtual address to correspond to the actual address by using mapping information stored in the mapping table.

Periodically or in the case where a particular condition is satisfied, the storage device 300a may store the file data stored in the first memory 310 to the second memory 320. The storage device 300a may store file data at an actual address of the second memory 320 by using the mapping table and metadata.

FIG. 3 is a conceptual diagram for describing a method in which a processor of the electronic device illustrated in FIG. 2 manages data, according to an embodiment. For better understanding, FIG. 2 will be referenced together with FIG. 3 in the description below.

As described with reference to FIGS. 2 and 3, the processor 100a may manage data on a page basis.

In the case where a size of data stored at a page is smaller than a reference size, the processor 100a may record hint data at a page. The reference size may be smaller than or identical to a page size. For example, in some embodiments, the reference size may be the page size. For example, the reference size may be half the page size. That is, the reference size may be a block size. Below, a description will be given with the example that the reference size is the page size, but the inventive concept is not limited thereto. Also, the processor 100a may record hint data at a separate page.

The operating system 120 may input information about a file and/or file data to the file system 130 through a function (e.g., a write syscall function). In the case where a function is input from the operating system 120, the file system 130 may record file data at a page based on the function.

A particular function may include information about a file descriptor, an address of data, a count, etc. The file descriptor may indicate a file associated with file data. The address of data may indicate an address of a page at which file data will be stored. The address of data may be expressed as a virtual address. The count may indicate a size of file data.

In detail, referring to a first page (Page 1) in FIG. 3, the file system 130 may receive a write syscall function. The file system 130 may record file data 141 of 32 bytes at the first page based on the function. In this case, the size of the file data 141 recorded at the first page may be smaller than a size of the first page. Accordingly, the file system 130 may record hint data 151 at the first page. That is, the hint data 151 may indicate that the file data 141 recorded at the first page is smaller in size than the first page.

The hint data 151 may indicate an offset and a count of the file data 141. The offset may indicate an address at which the file data 141 starts to be recorded with respect to a start address of the first page. The count may indicate a size of the file data 141 recorded at the first page. For example, in the case where the file data 141 of 32 bytes are recorded from the start address of the first page, an offset value of the hint data 151 may be “0”, and a count value of the hint data 151 may be “32”.

Referring to a second page (Page 2) in FIG. 3, the file system 130 may receive an Iseek syscall function and a write syscall function. The file system 130 may record file data 142 of 32 bytes from an address spaced by 64 bytes from a start address of a second page based on a function. The file system 130 may record hint data 152 after recording the file data 142. For example, with regard to the hint data 152, an offset value may be “64” and a count value may be “32”.

Also, after recording the file data 142, the file system 130 may receive another Iseek syscall function and a write syscall function, and may record file data 143 based on the functions. The file data 143 of 32 bytes may be recorded from an address spaced by 3100 bytes from an address at which the recording of the file data 142 is completed. The file system 130 may record hint data 153 after recording the file data 143. For example, with regard to the hint data 153, an offset value may be “3196” and a count value may be “32”.

That is, in the case where a plurality of write requests are received from the operating system 120, the file system 130 may record two sets of hint data 152 and 153 at the second page. However, the inventive concept is not limited thereto. For example, in the case where a plurality of write requests are received from the operating system 120, the file system 130 may record only one set of hint data. In this case, an offset value of one set of hint data may be “64” corresponding to an offset value of the file data 142 recorded for the first time. A count value of one set of hint data may be “3164” corresponding to a difference between an offset value “3228” after the file data 143 are recorded and an offset value “64” of the file data 142 recorded for the first time.

Referring to a third page (Page 3) in FIG. 3, the file system 130 may receive the write syscall function. The file system 130 may record file data 144 of 4096 bytes at the third page based on the function. In this case, the size of the file data 144 recorded at the third page may be identical to a size of the third page. Accordingly, the file system 130 may not record hint data at the third page.

The processor 100a may identify pages including file data smaller than a size of a page based on the hint data 151, 152, and 153. In detail, a first page (Page 1) including the hint data 151 may be identified as including the file data 141 smaller than the size of the first page. The third page (Page 3) which does not include hint data may be identified as including the file data 144 identical to the size of the third page.

However, the inventive concept is not limited thereto. For example, the file system 130 may record hint data at all pages. In this case, the processor 100a may identify a page including file data, the size of which is smaller than the page size, by using a count value. In detail, in the case where a count value is smaller than the size of the first page, the first page may be identified as including the file data 141, the size of which is smaller than the size of the first page. In the case where a count value is identical to the size of the third page, the third page may be identified as including the file data 144, the size of which is identical to the size of the third page.

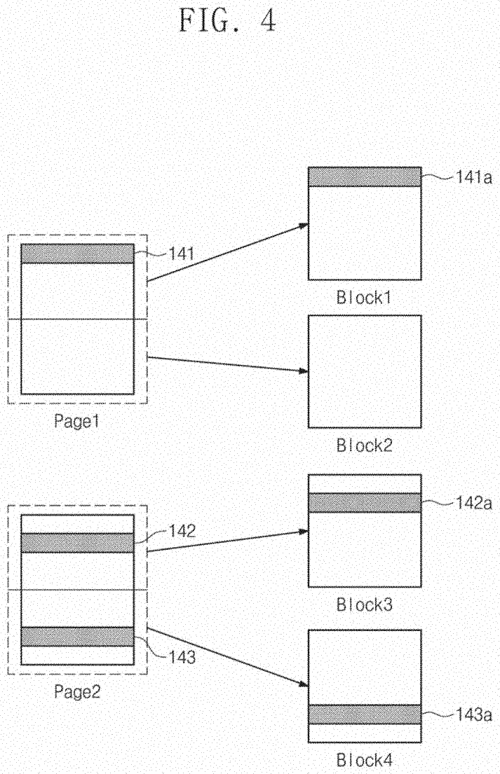

FIG. 4 is a conceptual diagram for describing a method in which a processor of the electronic device illustrated in FIG. 2 manages data, according to an embodiment. For better understanding, FIG. 2 will be referenced together with FIG. 4 in the description below.

As described with reference to FIGS. 2 and 4, the processor 100a may manage file data 141a, 142a, and 143a on a page basis within the processor 100a. However, the processor 100a may divide a page into blocks for the purpose of outputting the file data 141a, 142a, and 143a to the memory 200a and/or the storage device 300a.

The processor 100a may divide one page into blocks. The block size may be smaller than the page size. In the following descriptions, it is assumed that the block size is half the page size. The processor 100a may divide one page into two blocks. A first page (Page1) may be divided into a first block and a second block. The first block (Block1) may include the file data 141a. The file data 141a may be data identical to the file data 141. The second block (Block2) may not include file data, in this example.

A second page (Page2) may be divided into a third block (Block3) and a fourth block (Block4). The third block may include the file data 142a. The fourth block may include the file data 143a. The file data 142a and 143a may be data identical to the file data 142 and 143.

In each of the first block, the third bock, and the fourth block, meaningless data may be recorded in the remaining area where file data are not recorded. The processor 100a may output data on a block basis. Accordingly, the processor 100a may output data in the first block, the third block, and the fourth block for the purpose of outputting the file data 141a, 142a, and 143a. Since the data in the first block, the third block, and the fourth block are output, meaningless data may also be output to the memory 200a and/or the storage device 300a. In this case, the processor 100a may output data, the amount of which is significantly greater than the amount of the file data 141a, 142a, and 143a to execute a program. Since the large amount of data is exchanged between the processor 100a, and the memory 200a and the storage device 300a, a delay may occur upon transmitting data.

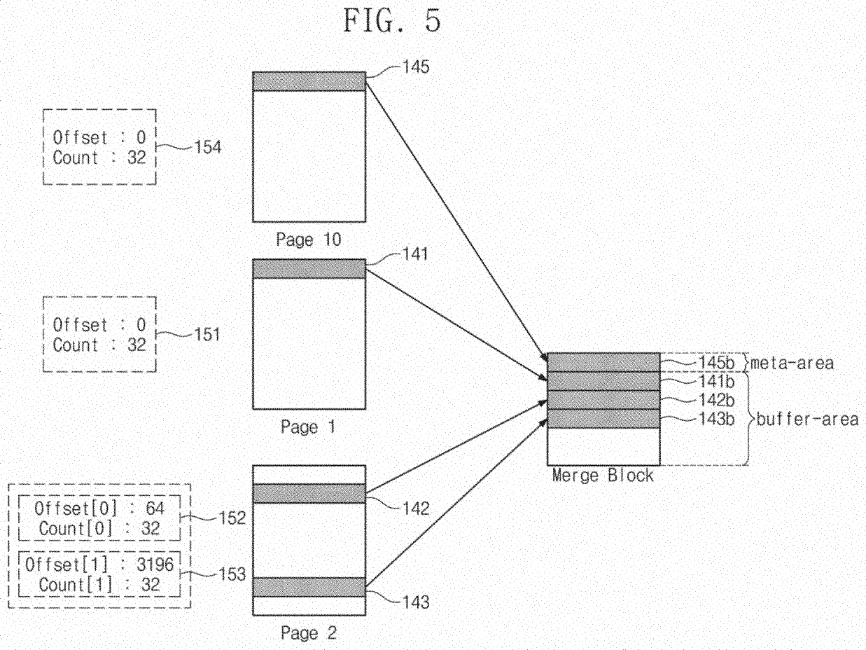

FIG. 5 is a conceptual diagram for describing a method in which a processor of the electronic device illustrated in FIG. 2 manages data, according to an embodiment. For better understanding, FIG. 2 will be referenced together with FIG. 5 in the description below.

As described with reference to FIGS. 2 and 5, the processor 100a may divide a page into blocks and may output file data 141b, 142b, and 143b to the memory 200a and/or the storage device 300a. Unlike the description given with reference to FIG. 4, the processor 100a may merge the file data 141, 142, and 143 to generate blocks. In detail, the processor 100a may generate blocks by merging the file data 141, 142, and 143 so that the file data 141, 142, and 143 are adjacent to each other without an empty space.

A first page (Page 1) may include hint data 151, and a second page (Page 2) may include hint data 152 and 153. The processor 100a may identify the first page and the second page including file data smaller in size than a page based on the hint data 151, 152, and 153.

The processor 100a may generate a merge block (Merge Block) by merging the file data 141, 142, and 143 of the identified first page and the identified second page. Only one merge block is illustrated in FIG. 5, but the inventive concept is not limited thereto. In the case where a sum of sizes of the file data 141, 142, and 143 is greater than a size of the merge block, the processor 100a may generate a plurality of merge blocks.

In processor 100a may generate a merge block by using the hint data 151, 152, and 153.

The processor 100a may read the file data 141 by using the hint data 151. In detail, the processor 100a may read data as much as a count value of “32” from an offset value of “0” which the hint data 151 indicates. The data which the processor 100a reads may denote the file data 141.

The processor 100a may read the file data 142 and 143 by using the hint data 152 and 153. In detail, the processor 100a may read data as much as a count value of “32” from an offset value of “64” which the hint data 152 indicates. The data which the processor 100a reads may denote the file data 142. The processor 100a may read data as much as a count value of “32” from an offset value of “3196” which the hint data 153 indicates. The data which the processor 100a reads may denote the file data 143.

A tenth page (Page 10) may include metadata 145 associated with attributes of the file data 141, 142, and 143. The metadata 145 may be associated with one or more files. The metadata 145 may indicate a size of file data included in one or more files and an address and/or position where file data are stored.

Similar to the description given with reference to FIG. 3 above, the processor 100a may record hint data 154 at the tenth page. For example, with regard to the hint data 154, an offset value may be “0” and a count value may be “32”.

The processor 100a may identify the tenth page including the metadata 145 smaller in size than a page based on the hint data 154. The processor 100a may read the metadata 145 by using the hint data 154. In detail, the processor 100a may read data as much as a count value of “32” from an offset value of “0” which the hint data 154 indicates. The data which the processor 100a reads may denote the metadata 145.

The processor 100a may merge the file data 141, 142, and 143 and the metadata 145 to generate a merge block (Merge Block). In detail, the processor 100a may generate a merge block by merging the file data 141, 142, and 143 and the metadata 145 so that the file data 141, 142, and 143 and the metadata 145 are adjacent to each other without an empty space as shown in FIG. 5. A size of the merge block may be smaller than a sum of a size of the first page, a size of the second page, and a size of the tenth page. The merge block may include a meta area and a buffer area. The processor 100a may store the file data 141b, 142b, and 143b in the buffer area. The processor 100a may store the meta data 145b associated with attributes of the file data 141b, 142b, and 143b in the meta area.

The file data 141b, 142b, and 143b and the metadata 145b may be identical to the file data 141, 142, and 143 and the metadata 145, respectively. That is, attribute information of the file data 141b, 142b, and 143b may be identical to attribute information of the file data 141, 142, and 143, respectively. In the case where the file data 141, 142, and 143 are generated to be stored in a space associated with a first position of the memory 320, the file data 141b, 142b, and 143b may be stored in the space associated with the first position. In this case, the metadata 145 and 145b may include information about the first position.

According to the method described with reference to FIG. 4, upon outputting a first block, the processor 100a may also output a second block associated with a first page. That is, the processor 100a may output blocks associated with one page together. In this case, the processor 100a may output four blocks for the purpose of recording the file data 141b, 142b, and 143b at the storage device 300a.

In contrast, according to the method described with reference to FIG. 5, the processor 100a may output data of one merge block for the purpose of recording the file data 141b, 142b, and 143b at the memory 200a and/or the storage device 300a. Since a block corresponds to a group of data, transmitting a block denotes transmitting data. Accordingly, compared with blocks illustrated in FIG. 4, the processor 100a may reduce the amount of data to be output to the memory 200a and/or the storage device 300a. In the case where the electronic device 1000a is a small-sized electronic device such as a smartphone, a tablet PC, or a wearable device, a situation in which a small size of data are recorded at the storage device 300a may frequently occur. In this case, according to the method described with reference to FIG. 5, the processor 100a may prevent meaningless data from being output. That is, the processor 100a may prevent the amount of data to be transmitted to the storage device 300a from increasing unnecessarily.

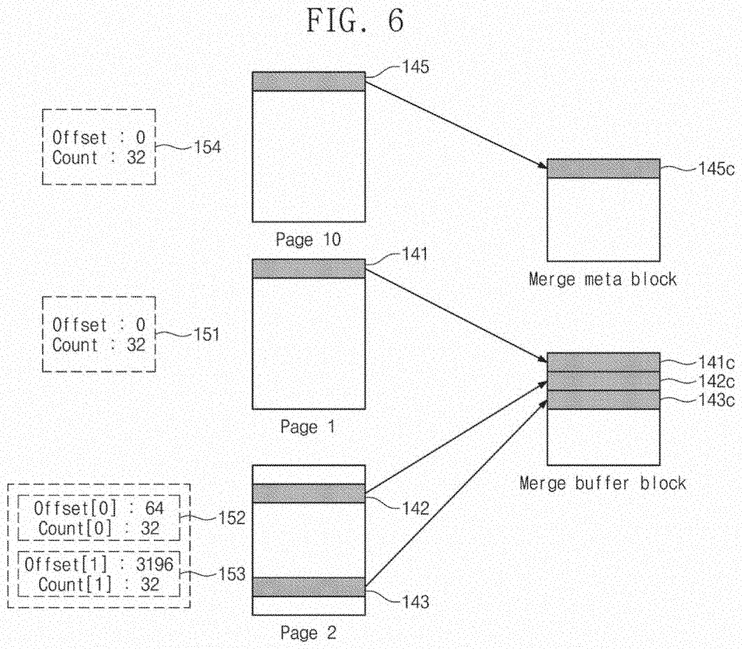

FIG. 6 is a conceptual diagram for describing a method in which a processor of the electronic device illustrated in FIG. 2 manages data, according to an embodiment. For better understanding, FIGS. 2, 5 and 6 will be referenced together in the description below.

A method of managing data, which will be described with reference to FIG. 6, may be similar to the method described with reference to FIG. 5. However, unlike the description given with reference to FIG. 5, the processor 100a may generate a merge buffer block and a merge meta block such that metadata 145c and file data 141c, 142c, and 143c are included in different merge blocks. The metadata 145c and the file data 141c, 142c, and 143c may correspond to the metadata 145b and the file data 141b, 142b, and 143b, respectively.

As described with reference to FIG. 5, the processor 100a may merge the file data 141, 142, and 143 to generate the merge buffer block. The merge buffer block may include the file data 141c, 142c, and 143c.

Similar to the way to merge the file data 141, 142, and 143, the processor 100a may generate the merge meta block by using the metadata 145. The metadata 145c may include attribute information of the file data 141c, 142c, and 143c included in the merge buffer block. The information included in the metadata 145c will be described with reference to Table 1 below.

TABLE 1

| Index | Final page address | Offset | Count |
|---|---|---|---|
| 0 | 5000 | 0 | 32 |
| 1 | 2000 | 64 | 32 |
| 2 | 2000 | 3196 | 32 |

An index may denote data included in the merge buffer block. In detail, index (0) may denote the file data 141c. A final page address may indicate a position of the second memory 320 where file data are stored. The final page address may be a virtual address. File data may be stored at an actual address corresponding to a virtual address. In detail, final page address 5000 may denote that the file data 141c are stored at an actual address corresponding to final page address 5000.

An offset and a count may be identical to an offset and a count included in hint data illustrated in FIG. 3.

The processor 100a may independently manage the metadata 145c and the file data 141c, 142c, and 143c by generating the merge meta block and the merge buffer block. In the following descriptions, it is assumed that the processor 100a generates the merge meta block and the merge buffer block.

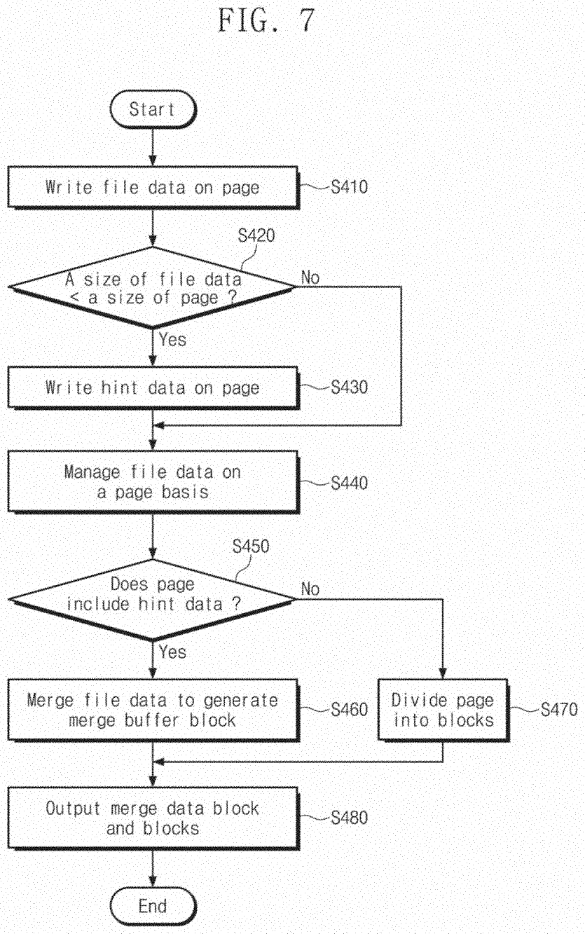

FIG. 7 is a flowchart for describing a method in which a processor of the electronic device illustrated in FIG. 2 manages data, according to an embodiment. For better understanding, FIGS. 3, 4, and 6 will be referenced together. A method in which the processor 100a generates a merge meta block is identical to a method in which the processor 100a generates a merge buffer block. Accordingly, a method in which the processor 100a generates a merge buffer block will be described with reference to FIG. 7, and separate description of a method of generating a merge meta block is omitted for conciseness.

In operation S410, the processor 100a may write file data at a page. Referring to FIG. 3, the processor 100a may record the file data 141 at a first page. The processor 100a may record the file data 142 and 143 at a second page. The processor 100a may record the file data 144 at a third page.

In operation S420, the processor 100a may compare a size of file data recorded at a page with a size of a page to determine whether the size of the file data is smaller than a size of the page.

When the size of the recorded file data is smaller than the page size (S420, Yes), in operation S430, the processor 100a may write hint data at the page. Returning to FIG. 3, the processor 100a may record the hint data 151 and the hint data 152 at the first page and the second page, respectively.

When the size of the recorded file data is identical to the page size (S420, No), the processor 100a may not write hint data at the page. Returning to FIG. 3, the processor 100a may not record hint data at a third page.

In operation S440, the processor 100a may manage file data on a page basis.

In operation S450, the processor 100a may determine whether a page includes hint data.

When the page includes hint data (S450, Yes), in operation S460, the processor 100a may merge file data included in the page to generate a merge buffer block. Returning to FIG. 6, the processor 100a may merge the file data 141, 142, and 143 to generate the merge buffer block.

When the page does not include hint data (S450, No), in operation S470, the processor 100a may divide the page into blocks. Returning to FIG. 4, the second page may be divided into two blocks.

In operation S480, the processor 100a may output the merge buffer block or the blocks to the memory 200a and/or the storage device 300a. That is, the processor 100a may transmit the merge buffer block or the blocks to the memory 200a and/or the storage device 300a.

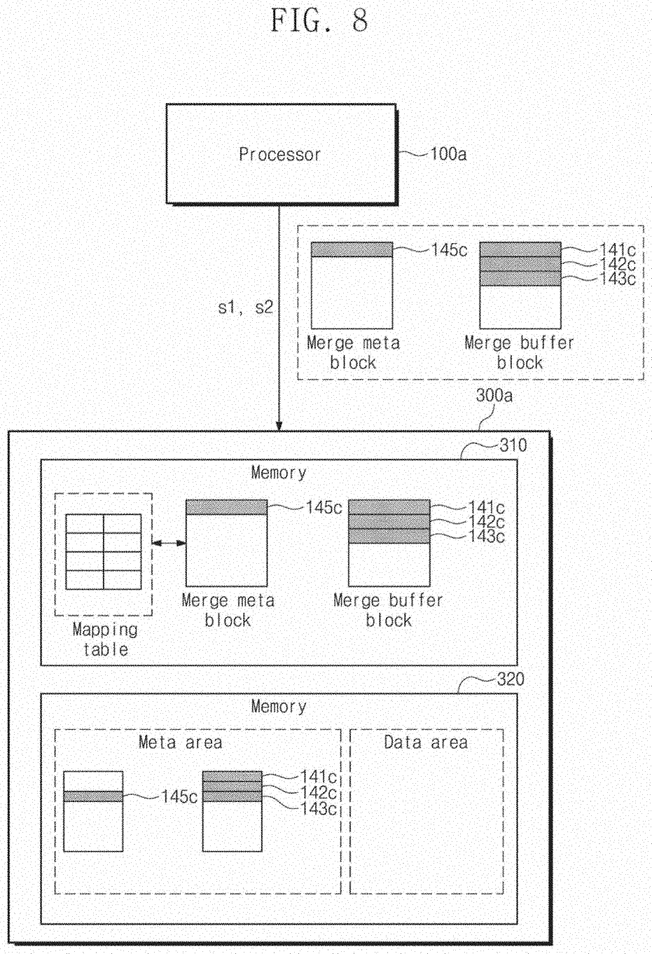

FIG. 8 is a conceptual diagram for describing a method of storing data at a storage device of the electronic device illustrated in FIG. 2, according to an embodiment. For better understanding, FIGS. 6 and 8 will be referenced together in the description below.

The processor 100a may transmit a signal s1 to the storage device 300a. The signal s1 may include a merge meta block and a merge buffer block. The storage device 300a may receive the signal s1. The storage device 300a may store the merge meta block and the merge buffer block based on the signal s1.

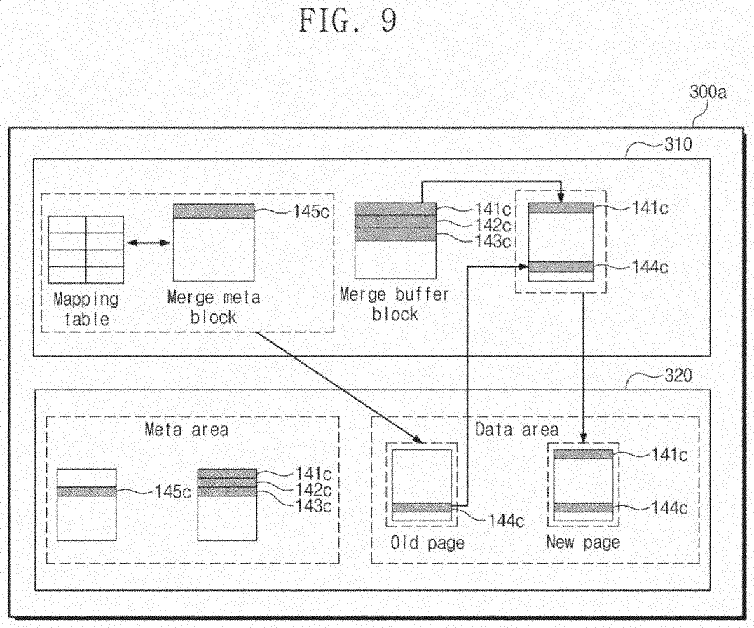

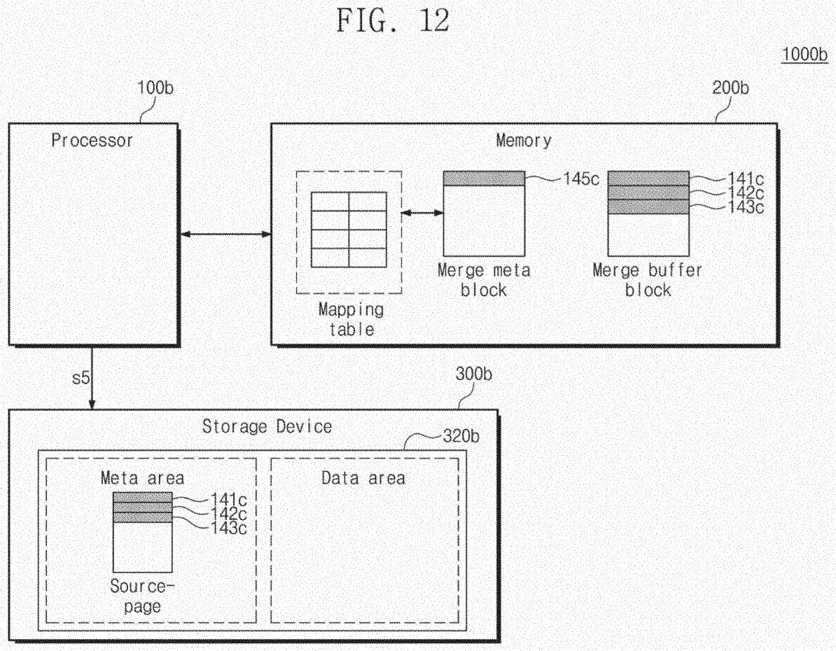

Information and/or a request associated with the merge meta block and the merge buffer block included in the signal s1 may be defined in a merge application program interface (API). In some embodiments, the merge application program API may be implemented by the memory controller in conjunction with the buffer of the storage device 300 (or 300a, or 300b described below with reference to FIG. 12). The storage device 300a may store the merge meta block and the merge buffer block to the first memory 310 in compliance with the merge API. Also, the storage device 300a may store the file data 141c, 142c, and 143c to the second memory 320 in compliance with the merge API. A method in which the storage device 300a stores the file data 141c, 142c, and 143c in compliance with the merge API will be described with reference to FIGS. 9 to 11.

In detail, in the case where the signal s1 is received, the storage device 300a may store the merge meta block and the merge buffer block to the first memory 310. As described with reference to FIG. 2, the first memory 310 may store a mapping table. The mapping table may be used to map a virtual address onto an actual address. The mapping table may include information about mapping between a virtual address and an actual address corresponding to the virtual address. The metadata 145c may indicate virtual addresses of the file data 141c, 142c, and 143c. The storage device 300a may obtain information about actual addresses corresponding to the virtual addresses of the file data 141c, 142c, and 143c by using the mapping table and the metadata 145c.

The processor 100a may transmit a signal s2 to the storage device 300a. The storage device 300a may receive the signal s2. The storage device 300a may perform journaling on the metadata to journal the metadata 145c stored in the first memory 310 to the second memory 320, based on the signal s2. In the case where a power supplied to the electronic device 1000a is suddenly turned off or in the case where the electronic device 1000a is abnormally terminated, the first memory 310 may lose data stored therein. The “journaling” denotes storing the metadata 145c stored in the first memory 310 to the second memory 320 for the purpose of coping with the above situation. The processor 100a may output the signal s2 such that the journaling is performed periodically. For example, the signal s2 may be a flush command. Also, the storage device 300a may automatically perform the journaling every given period.

As described with reference to FIG. 5, in the case where the electronic device 1000a is a small-sized device, a small size of data may be frequently transmitted from the processor 100a to the storage device 300a. As such, the number of times that the signal s2 is generated may increase. In the case where the journaling is performed by the signal s2, the storage device 300a may transmit the merge meta block including the metadata 145c to the meta area. According to an embodiment, as the number of merge data blocks decreases, the number of merge meta blocks may also decrease. That is, in the case where the journaling is performed, the amount of data which are transmitted from the first memory 310 to the second memory 320 may decrease.

The second memory 320 may include the meta area and a data area. Below, a description will be given of an example in which the second memory 320 is implemented with a NAND flash memory, but the inventive concept is not limited thereto. The second memory 320 may temporarily store data stored in the first memory 310 and may output the stored data. For example, in the case where the journaling is performed, the second memory 320 may store the metadata 145c. In the case where a power supplied to the electronic device 1000a is turned off and then is turned on, the second memory 320 may output the metadata 145c stored in the meta area to the first memory 310. Accordingly, the meta area may be implemented with a relatively fast memory cell such as a single level cell (SLC). In contrast, the number of times that data are input and output to and from the data area may be smaller than the number of times that data are input and output to and from the meta area. Accordingly, the data area may be implemented with a relatively slow memory cell such as a multi-level cell (MLC) or a triple level cell (TLC).

In some embodiments, the storage device 300a may store the file data 141c, 142c, and 143c in the meta area. For example, in the case where an available storage space is in use or otherwise not available in the first memory 310, the storage device 300a may store the file data 141c, 142c, and 143c in the meta area.

An example is illustrated in FIG. 8 in which the file data 141c, 142c, and 143c are stored in the first memory 310 and the meta area, but the inventive concept is not limited thereto. Table 2 below shows the case where the file data 141c is stored in the first memory 310 and the file data 142c and 143c are stored in the meta area. The metadata 145c may include information indicating whether the file data 142c and 143c are stored in any one of the first memory 310 and the meta area. The information included in the metadata 145c will be described with reference to Table 2 below.

TABLE 2

| | Current | Current | Final page | | |
|---|---|---|---|---|---|
| Index | position | address | address | Offset | Count |
| 0 | 0 | 10 | 5000 | 0 | 32 |
| 1 | 1 | 50000 | 2000 | 64 | 32 |
| 2 | 1 | 51000 | 2000 | 3196 | 32 |

The index, the final page address, the offset, and the count are described with reference to Table 1, and thus, additional description will be omitted for conciseness and to avoid redundancy. A current position may indicate whether file data are stored in any one of the first memory 310 and the meta area. The case where a value of the current position is “0” may denote that file data are stored in the first memory 310. The case where a value of the current position is “1” may denote that file data are stored in the meta area. A current address may indicate an address of a current position where file data are stored. For example, the metadata 145c may indicate that the file data 141c are stored in a space of the first memory 310 corresponding to an address of “10”. For another example, the metadata 145c may indicate that the file data 142c are stored in a space of the meta area corresponding to an address of “50000”.

FIG. 9 is a conceptual diagram for describing a method in which a storage device of the electronic device illustrated in FIG. 2 stores file data in a data area, according to an embodiment.

As described with reference to FIG. 8, the storage device 300a may store the file data 141c, 142c, and 143c to the first memory 310 and/or the meta area of the storage device 330. In the case where a particular condition is satisfied, the storage device 300a may store the file data 141c, 142c, and 143c stored in the first memory 310 and/or the meta area in the data area.

For another example, the storage device 300a may store the file data 141c, 142c, and 143c in the data area periodically.

For another example, in the case where a storage space for storing new metadata is in use or otherwise not available in the first memory 310, the storage device 300a may store the file data 141c, 142c, and 143c in the data area. After storing the file data 141c, 142c, and 143c to the data area, the storage device 300a may delete the metadata 145c. The storage device 300a may secure a storage space for storing new metadata by deleting the metadata 145c.

For another example, in the case where a storage space for storing new file data is in use or otherwise not available in the first memory 310 or in the case where a storage space for storing new file data is in use or otherwise not available in the meta area, the storage device 300a may store the file data 141c, 142c, and 143c in the data area. After storing the file data 141c, 142c, and 143c to the data area, the storage device 300a may delete the file data 141c, 142c, and 143c. The storage device 300a may secure a storage space for storing new file data by deleting the file data 141c, 142c, and 143c.

For another example, in the case where a signal is not received from the processor 100a or in the case where the number of times that a signal is received from the processor 100a is small, the storage device 300a may store the file data 141c, 142c, and 143c in the data area. The storage device 300a may measure an I/O load of the storage device 300a. The “I/O load” denotes the amount of work that the storage device 300a may perform in response to a signal received from the processor 100a. For another example, in the case where the I/O load is small, the storage device 300a may store the file data 141c, 142c, and 143c in the data area. Below, an operation in which the storage device 300a stores the file data 141c, 142c, and 143c in the data area is called a “store operation”.

As the number of times that a signal is input to the storage device 300a increases, the I/O load may increase. Any other operations may not be performed while the storage device 300a performs the store operation. That is, any other operations may be delayed while the storage device 300a performs the store operation. While the number of times that a signal is received is small and the I/O load is small, the storage device 300a may perform the store operation, thus reducing the burden on a delay of any other operations. Also, the storage device 300a may perform the store operation based on the I/O load, thus preventing a storage space of the storage device 300a from becoming insufficient, in advance. Accordingly, the performance of the storage device 300a may be improved.

In the case where a particular condition is satisfied, the storage device 300a may search for the metadata 145c. The storage device 300a may search for the metadata 145c to determine file data to be stored in the data area. In the following descriptions, it is assumed that the storage device 300a determines the file data 141c to be stored in the data area.

As described with reference to FIG. 9, the storage device 300a may obtain information about an actual address at which the file data 141c are to be stored, by using the mapping table and the metadata 145c. The actual address may indicate an old page (Old page) of the data area. The old page may be a page where the file data 144c associated with the file data 141c are recorded. That the file data 144c are associated with the file data 141c may denote that the file data 141c and 144c are used to execute the same program.

The storage device 300a may read the file data 144c stored at the old page. The storage device 300a may read the file data 141c stored in the first memory 310 and/or the meta area. The storage device 300a may merge the file data 141c and 144c in the first memory 310. The storage device 300a may assign a new page (New page) to the data area. The storage device 300a may record the merged file data 141c and 144c at the new page.

The second memory 320 may read or store data on a page basis. A size of a page which is used in the second memory 320 may be greater than a size of a page which is used in the processor 100a. For example, a size of a page which is used in the processor 100a may be 4 KB, while a size of a page which is used in the second memory 320 may be 16 KB or 32 KB. Accordingly, file data included in a plurality of merge buffer blocks may be stored at one page of the data area. Upon storing file data in the data area, the storage device 300a may simultaneously record file data to be stored at the same page in the data area. Accordingly, a speed of the second memory 320 may be improved. Also, an available time of the second memory 320 may become longer.

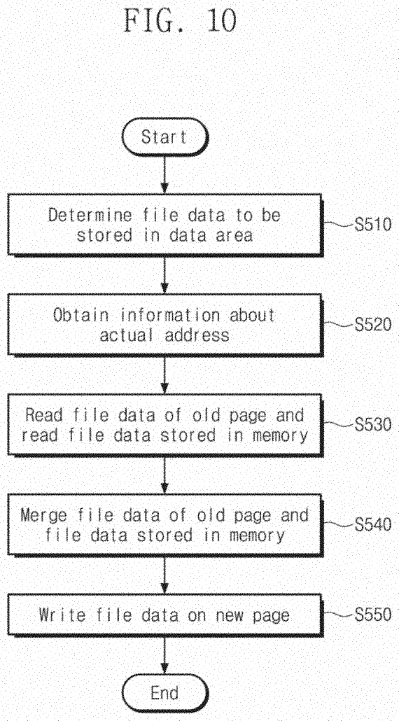

FIG. 10 is a flowchart for describing a method in which a storage device of the electronic device illustrated in FIG. 2 stores file data in a data area, according to an embodiment. For better understanding, FIG. 9 will be referenced together with FIG. 10 in the description below.

In the case where a particular condition is satisfied, in operation S510, the storage device 300a may determine the file data 141c to be stored in the data area.

In operation S520, the storage device 300a may obtain information about an actual address at which the file data 141c are to be stored. The storage device 300a may obtain the information about the actual address at which the file data 141c are to be stored by using the mapping table and the metadata 145c. The actual address may indicate an old page of the data area.

In operation S530, the storage device 300a may read the old page. In detail, the storage device 300a may read the file data 144c stored at the old page. Also, the storage device 300a may read the file data 141c stored in the first memory 310 and/or the meta area.

In operation S540, the storage device 300a may merge the read file data 141c and 144c. That is, the storage device 300a may merge the file data of the old page and the file data stored in the first memory 310.

In operation S550, the storage device 300a may write the merged file data 141c and 144c at a new page. For example, the storage device 300a may record or program the merged file data 141c and 144c at the new page. The storage device 300a may perform operations of the first memory 310 and operations of the second memory 320 in parallel. In detail, the storage device 300a may search for the metadata 145c while performing operation S540 and/or operation S550. Accordingly, while performing operation S540 and/or operation S550, the storage device 300a may determine file data to be stored in the data area after the file data 141c are stored. Thus, according to an embodiment, operations of the storage device 300a may be performed efficiently. Also, the performance of the storage device 300 may be improved.

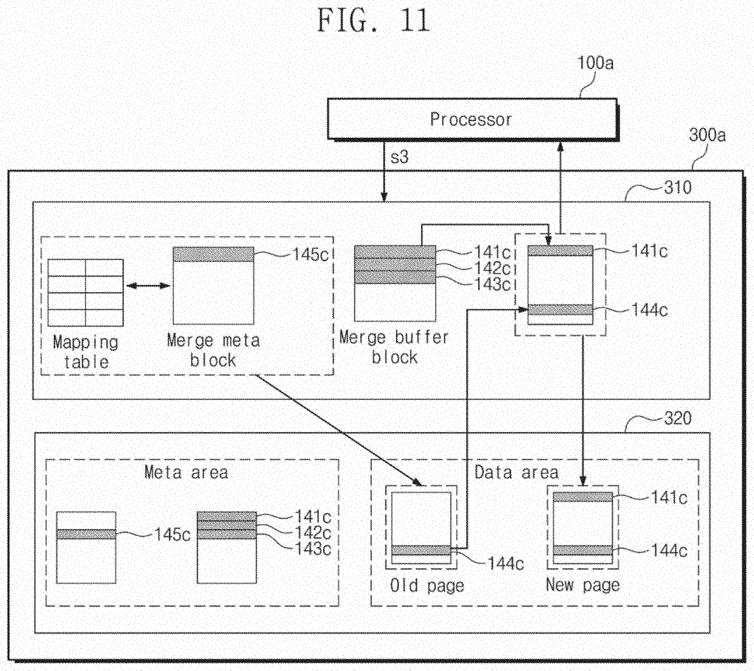

FIG. 11 is a conceptual diagram for describing a method in which a storage device of the electronic device illustrated in FIG. 2 reads file data, according to an embodiment. For better understanding, FIG. 8 will be referenced together with FIG. 11 in the description below.

The storage device 300a may receive a signal s3 from the processor 100a. The signal s3 may be a command and/or a signal for requesting a read operation from the storage device 300a. The processor 100a may request file data stored at an old page from the storage device 300a through the signal s3.

The signal s3 may include information about an address of the old page. The storage device 300a may compare a final position address included in the metadata 145c and an address which the signal s3 indicates.

In the case where the same address as the address which the signal s3 indicates is in use or otherwise not available in the final position address included in the metadata 145c, the storage device 300a may not read the file data 141c, 142c, and 143c stored in the memory 310. The storage device 300a may read the file data 144c stored at the old page. The storage device 300a may transmit the file data 144c to the processor 100a. That is, the storage device 300a may output only the file data 144c stored in the data area without considering the file data 141c, 142c, and 143c stored in the first memory 310.

In the case where the same address as the address which the signal s3 indicates is present at the final position address included in the metadata 145c, the storage device 300a may read the file data 141c, 142c, and 143c stored in the memory 310. Below, it is assumed that the final position address of the file data 141c is identical to the address which the signal s3 indicates. The storage device 300a may read the file data 141c stored in the first memory 310. Also, the storage device 300a may read the file data 144c stored at the old page. As described with reference to FIG. 10, the storage device 300a may merge the file data 141c and 144c. The storage device 300a may transmit the merged file data 141c and 144c to the processor 100a. That is, the storage device 300a may output the file data 141c, 142c, and 143c stored in the first memory 310 as well as the file data 144c stored in the data area. Also, the storage device 300a may record the merged file data 141c and 144c at a new page. Similar to the store operation described with reference to FIG. 10, read operations may be performed in parallel. Since read operations are performed in parallel, the storage device 300a may obtain the same effect as described with reference to FIG. 10. Below, the descriptions given above are omitted to avoid redundancy.

FIG. 12 is a block diagram illustrating an exemplary configuration of an electronic device according to an embodiment. For better understanding, FIG. 2 will be referenced together with FIG. 12 in the description that follows.

An electronic device 1000b may include a processor 100b, a memory 200b, and a storage device 300b. Operations and configurations of the processor 100b, the memory 200b, and the storage device 300b may be similar to those of the processor 100a, the memory 200a, and the storage device 300a illustrated in FIG. 2. However, unlike the description given with reference to FIG. 2, operations which the first memory 310 of the electronic device of FIG. 2 provides may be provided by the memory 200b. For example, the memory 200b may be a virtual storage device which is operated by a virtual storage driver in an operating system. For another example, the memory 200b may be implemented with a physical storage device such as a ROM or a RAM.

As described with reference to FIG. 2, the processor 100b may merge the metadata 145c to generate a merge meta block. The processor 100b may merge the file data 141c, 142c, and 143c to generate a merge buffer block.

The processor 100b may transmit the merge meta block and the merge buffer block to the memory 200b. Unlike the description given with reference to FIG. 2, the memory 200b may store a merge meta block, a merge buffer block, and a mapping table. That is, operations and configurations which are provided by the first memory 310 illustrated in FIG. 2 may be implemented by the memory 200b.

The processor 100b may transmit a signal s5 to the storage device 300b. The signal s5 may correspond to the signal s2 described with reference to FIG. 8. However, unlike the signal s2, the signal s5 may omit a merge meta block.

The storage device 300b may include a memory 320b. The memory 320b may provide configurations and operations corresponding to the second memory 320 illustrated in FIG. 2. In detail, the memory 320b may be a nonvolatile memory.

The memory 320b may include a meta area and a data area. For example, the meta area and the data area may be implemented with nonvolatile memories physically separated from each other. In this case, as in the description given with reference to FIG. 8, the meta area may be implemented with a relatively fast memory cell such as a single level cell (SLC). The data area may be implemented with a relatively slow memory cell such as a multi-level cell (MLC) or a triple level cell (TLC). For another example, the meta area and the data area may be implemented with one memory. In this case, the meta area and the data area may be logically partitioned areas.

The storage device 300b may receive the signal s5. The storage device 300b may store the file data 141c, 142c, and 143c in the meta area based on the signal s5. The file data 141c, 142c, and 143c included in the marge buffer block may be transferred from memory 200b to storage device 300b through the processor 100b. As described with reference to FIG. 9, the storage device 300b may store the file data 141c, 142c, and 143c on a page basis. The file data 141c, 142c, and 143c may be stored at a source page of the meta area.

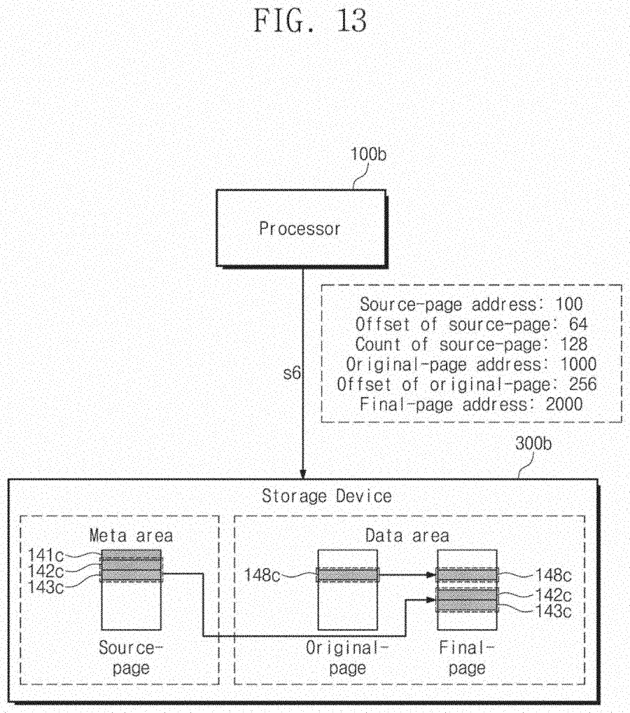

FIG. 13 is a conceptual diagram for describing a method in which a storage device of the electronic device illustrated in FIG. 12 stores file data to a data area, according to an embodiment.

As described with reference to FIG. 12, the storage device 300b may store the file data 141c, 142c, and 143c in the meta area. The processor 100b may transmit a signal s6 to the storage device 300b. The storage device 300b may receive the signal s6. The signal s6 may include information used to store the file data 141c, 142c, and 143c stored in the meta area in the data area.

The signal s6 may include information about the file data 142c and 143c, which are to be stored in the data area, from among the file data 141c, 142c, and 143c stored in the meta area. For example, the signal s6 may include information about an address of a source page (Source page) including the file data 142c and 143c, positions of the source page where the file data 142c and 143c are stored, and sizes of the file data 142c and 143c. In detail, file data of 128 bytes from an offset value of “64” at a source page having an address of “100” may correspond to the file data 142c and 143c.

The signal s6 may include information about a position where file data 148c associated with the file data 142c and 143c are stored. The file data 148c and the file data 142c and 143c may be used to execute the same program. For example, the signal s6 may include information about an address of an original page where the file data 148c are stored and the file data 148c. In detail, the storage device 300b may read the file data 148c by reading a space from a start address of an original page having an address of “1000” to an offset value of “256”.

The signal s6 may include information about a position of the data area where the file data 142c and 143c are stored. For example, the signal s6 may include an address of a final page where the file data 142c and 143c are to be stored. The storage device 300b may record the file data 142c, 143c, and 148c at the final page. In detail, the storage device 300b may record the file data 142c, 143c, and 148c at the final page having an address of “2000”.

That is, unlike the storage device 300a, the storage device 300b may read the file data 142c, 143c, and 148c based on information included in the signal s6. Also, unlike the storage device 300a of FIG. 2, the storage device 300b may record the file data 142c, 143c, and 148c at the data area based on information included in the signal s6.

Information and/or a request included in the signal s6 may be defined in an internal merge application program interface (API). The storage device 300b may store the file data 142c and 143c in the data area in compliance with the internal merge API.

For example, the storage device 300b may store the file data 142c and 143c in the data area immediately in the case where the signal s6 is received.

For another example, in the case where a particular condition is satisfied, the storage device 300b may store the file data 141c, 142c, and 143c in the data area based on the signal s6. The particular condition may be similar to the particular condition described with reference to FIG. 9. In detail, the storage device 300b may store the file data 142c and 143c stored in the meta area to the data area periodically. In the case where a storage space for storing new file data is in use or otherwise not available in the meta area, the storage device 300b may store the file data 142c and 143c in the data area. After storing the file data 142c and 143c in the data area, the storage device 300b may delete the file data 142c and 143c stored at a source page. In the case where a signal is not received from the processor 100b or in the case where the number of times that a signal is received from the processor 100b is small, the storage device 300b may store the file data 142c and 143c in the data area. In the case where the I/O load is small, the storage device 300b may store the file data 142c and 143c in the data area.

According to an embodiment, by the internal merge API, the amount of data which are transmitted from the processor 100b to the storage device 300b may decrease. In detail, the processor 100b may omit transmitting the merge meta block illustrated in FIG. 12 by transmitting the signal s6. Accordingly, the amount of data stored in the storage device 300b may also decrease.

Also, the file data 141c may be recorded at the same final page as the file data 142c and 143c. In this case, the processor 100b may output the signal s6 including information about the file data 141c. Accordingly, the number of times that the signal s6 is output from the processor 100b may decrease.

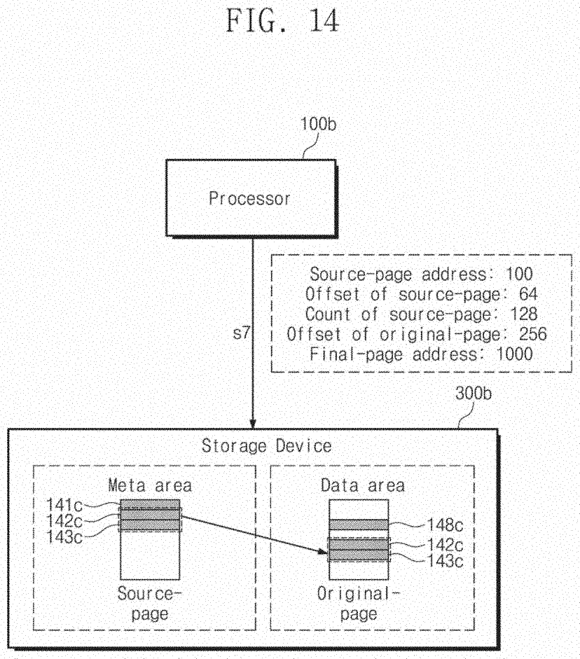

FIG. 14 is a conceptual diagram for describing a method in which a storage device of the electronic device illustrated in FIG. 12 stores file data in a data area, according to an embodiment. For better understanding, FIG. 13 will be referenced together with FIG. 14 in the description below.

The processor 100b may set an original page and a final page identically or differently, depending on a kind of a file system used in the processor 100b. In the case where the original page and the final page are identical, the processor 100b may output a signal s7. Unlike the signal s6, the signal s7 may omit information about the original page. However, the inventive concept is not limited thereto. For example, the signal s7 may include one of information about the original page and information about the final page.

Similar to the method described with reference to FIG. 13, the storage device 300b may record the file data 142c, 143c, and 148c in the data area. However, unlike the description given with reference to FIG. 13, the storage device 300b may overwrite the file data 142c and 143c on the original page.

Accordingly, referring to FIGS. 13 and 14, the internal merge API may be used in the storage device 300b regardless of a kind of a file system used in the processor 100b. For example, in the case where the processor 100b uses a file system such as an LFS, the signal s6 may be transmitted. In this case, the storage device 300b may store the file data 142c and 143c in the data area through the method described with reference to FIG. 13. For another example, in the case where the processor 100b uses a file system such as an EXT4, the signal s7 may be transmitted. In this case, the storage device 300b may store the file data 142c and 143c in the data area through the method described with reference to FIG. 14.

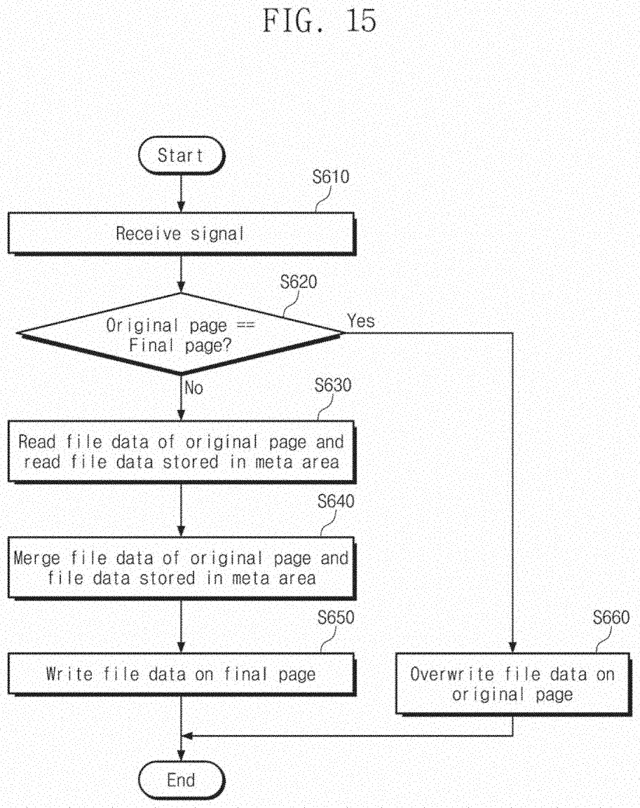

FIG. 15 is a flowchart for describing a method in which a storage device of the electronic device illustrated in FIG. 12 stores file data in a data area, according to an embodiment. For better understanding, FIGS. 13 and 14 will be referenced together with FIG. 15 in the description below.

In operation S610, the storage device 300b may receive a signal from the processor 100b.

In operation S620, it is determined whether an original page is the same as a final page. For example, the storage device 300b may receive the signal s6 or the signal s7. That the signal s6 is received may denote that an original page and a final page are different. That the signal s7 is received may denote that the original page and the final page are identical.

When the original page and the final page are different (S620, No), in operation S630, the storage device 300b may read the original page. That is, the storage device 300b may receive the file data 148c. Also, the storage device 300b may read the file data 142c and 143c stored in the meta area.

In operation S640, the storage device 300a may merge the file data 148c and the file data 142c and 143c.

In operation S650, the storage device 300b may write the file data on the final page. That is, the storage device 300b may record the merged file data 142c, 143c, and 148c at the final page.

When the original page and the final page are identical (S620, Yes), in operation S660, the storage device 300b may overwrite the file data 142c and 143c on the original page.

According to an embodiment, an electronic device may reduce the amount of data to be transmitted to a storage device. Also, the electronic device may reduce the number of times that a write operation is performed in the storage device. Accordingly, the performance of the storage device may be improved, and an available time of the storage device may become longer.

While the inventive concept has been described with reference to various exemplary embodiments thereof, it will be apparent to those of ordinary skill in the art that various changes and modifications may be made thereto without departing from the spirit and scope of the present disclosure as set forth in the following claims.

1. An electronic device comprising:
a memory configured to store first partial data generated with regard to a first position of a data area of a storage device and second partial data generated with regard to a second position of the data area; and
a processor,
wherein, when a first size of the first partial data included in a first page is smaller than a reference size and a second size of the second partial data included in a second page different from the first page is smaller than the reference size, the processor outputs one or more data blocks including the first partial data and the second partial data, and outputs first metadata including first information about the first position with regard to the first partial data and second metadata including second information about the second position with regard to the second partial data,
wherein a size of the one or more data blocks is smaller than a first sum of a size of the first page and a size of the second page.

2. The electronic device of claim 1, wherein the processor merges the first partial data and the second partial data to generate the one or more data blocks.

3. The electronic device of claim 1, wherein the processor generates the one or more data blocks such that the first metadata and the second metadata are included in the one or more data blocks.

4. The electronic device of claim 1, wherein, when a size of the first metadata included in a third page is smaller than the reference size and a size of the second metadata included in a fourth page is smaller than the reference size, the processor generates one or more meta blocks including the first metadata and the second metadata, and
wherein the size of the one or more meta blocks is smaller than a second sum of a size of the third page and a size of the fourth page.

5. The electronic device of claim 1, wherein the processor generates first hint data when the first size is smaller than the reference size and generates second hint data when the second size is smaller than the reference size.

6. The electronic device of claim 5, wherein the first hint data is associated with the first size and a position of the first partial data in the first page, and
wherein the second hint data is associated with the second size and a position of the second partial data in the second page.

7. The electronic device of claim 1, wherein the reference size is not greater than the first size.

8. The electronic device of claim 1, wherein the memory stores the first metadata, the second metadata, and the one or more data blocks, and
wherein the processor outputs a signal for recording the first partial data at the data area, the first partial data being recorded at the data area based on the first metadata that is stored, the second metadata that is stored, and the one or more data blocks that is stored.

9. The electronic device of claim 8, wherein the signal includes the first information about the first position or includes the first information about the first position and third information about a third position of the data area, at which the first partial data are stored.

10. A storage device comprising:
a first memory configured to store one or more data blocks generated by merging partial data respectively included in pages and to store first metadata of first partial data, which are generated with regard to a first position, from among the partial data; and
a second memory configured to store the first partial data at a second position associated with the first position by using the first metadata,
wherein a size of the one or more data blocks is smaller than a size of each of the pages.

11. The storage device of claim 10, wherein the first memory is a volatile memory and the second memory is a nonvolatile memory.

12. The storage device of claim 10, wherein, when original data associated with the first partial data are stored at the first position, the second memory stores the original data at the second position.

13. The storage device of claim 10, wherein, in a case where the second memory stores the first partial data at the second position, the second memory stores second partial data, which are generated with regard to the first position, from among the partial data at the second position.

14. The storage device of claim 10, wherein the first memory searches for metadata associated with the partial data to determine the first partial data to be stored in the second memory.

15. The storage device of claim 10, wherein, when a condition is satisfied, the second memory stores the first partial data, and
wherein the condition is associated with an amount of signals received from the outside or an input/output load generated by the signals.

16. A storage device comprising:
a first memory configured to receive one or more data blocks generated by merging partial data respectively included in pages and to store the partial data; and
a second memory,
wherein, in response to a signal including first information about a first position of the first memory and second information about a second position being received at the first memory, the second memory stores, at the second position, first partial data, which are stored at the first position, from among the partial data based on the signal,
wherein a size of the one or more data blocks is smaller than a size of the pages. and
wherein a size of the partial data is smaller than a size of each of the pages.

17. The storage device of claim 16, wherein the first memory and the second memory are a nonvolatile memory.

18. The storage device of claim 16, wherein the signal includes offset information about an offset at which the first partial data are located, and count information about a count associated with a size of the first partial data, and
wherein the second memory stores, at the second position, the first partial data according to the count and the offset, based on the signal.

19. The storage device of claim 16, wherein the signal further includes third information about a third position of the first memory, and
wherein the second memory stores, at the second position, second partial data, which are stored at the third position, from among the partial data based on the signal.

20. The storage device of claim 16, wherein, when the signal includes fourth information about a fourth position of the second memory different from the second position of the second memory, the second memory stores the first partial data and original data, which are stored at the fourth position, at the second position.

21-25. (canceled)
